(19) United States
(12) Patent Application Publication
(10) Pub. No.: US 2005/0279775 A1
(43) Pub. Date: Dec. 22, 2005

(54) Container for distribution of non-catalyzed resin and filler mixture

(76) Inventor: John Polimeno, Discovery Bay, CA (US)

Correspondence Address: T LESTER WALLACE, 6601 KOLL CENTER PARKWAY, SUITE 245, PLEASANTON, CA, 94566, US

(21) Appl. No.: 10/863,035

(22) Filed: Jun. 7, 2004

(51) Int. Cl. B67D 5/42

(52) U.S. Cl. 222/386

(57) ABSTRACT

A non-catalyzed mixture of polyester resin and filler, in the proper proportions for use in the manufacture of cast resin articles such as cultured marble, is vacuum-packed into a novel airtight shipping and dispensing container. A container typically contains two to five hundred pounds of the resin/filler mixture. Rather than supplying resin and filler starting materials to fabricators as separate materials, the resin and filler starting materials are supplied in a pre-mixed condition in the airtight containers. In one embodiment, a fabricator uses a novel dispensing and mixing machine to extract a desired amount of non-catalyzed resin and filler mix from a container. The machine mixes a catalyst into the extracted mixture and the resulting catalyzed mixture is output from the machine. Efficiencies in the distribution and transport of the starting materials can be realized. Inventory control can be simplified. Quality and uniformity of the resulting cast articles is facilitated.

### TECHNICAL FIELD

The present invention relates to processes and structures for casting molded articles out of cured resin and for supplying and distributing starting materials for the manufacture of cured resin articles.

### BACKGROUND

Cast resin processes are commonly used to make articles such as vanity tops, vanity basins, bath tubs, and shower pans. Cultured marble is a term that is commonly used to describe one type of cast resin material.

FIG. 1 (Prior Art) is a simplified diagram that illustrates one method of making cultured marble. A liquid polyester resin material is used (step 1) as a starting ingredient. An effective amount of a catalyst such as an organic peroxide is then added (step 2). The two materials are mixed. Calcium carbonate, in granular and/or powder form, is then added (step 3). The calcium carbonate is to act as a filler in the finished material. Approximately twenty weight percent of the mixture is resin and approximately eighty percent weight percent of the mixture is filler. Pigment can be added at this stage if desired. The mixture has a soupy consistency much like the consistency of runny cookie dough. The surface of a mold is coated with a clear layer of polyester resin commonly referred to as gel coat. After the gel coat has partially cured, the soupy resin/filler mixture is poured (step 4) into the mold. After the mold is filled, the mold is typically vibrated in a vacuum chamber (step 5) in order to release air bubbles that may have adhered to the calcium carbonate filler particles or that may have adhered to the inside surface of the gel coat or mold. The material in the molds is then allowed to cure and harden. The hardened resin holds the filler particles in place to form a matrix. The matrix, which is removed (step 6) from the mold, is the article.

Another type of cast resin material is made using aluminum trihydrate (ATH) as a filler, rather than calcium carbonate. This cast resin material is sometimes called cast onyx. In the cast onyx process, a get coat layer is not used. Otherwise, the process of making cast onyx is much the same as the cultured marble process described above except that the filler material is aluminum trihydrate rather than calcium carbonate.

To make a cast resin material that has the appearance of granite, the cast resin material using ATH as filler is used as a starting material. After curing, the material is crushed into particles of the sizes of crystals that are seen in natural granite. Sheets of cast resins of different colors are crushed such that the resulting particles are of the different colors seen in natural granite. The resulting colored particles are then used as the filler material in the resin/filler process described above. When the resin cures, the particles of different colors are held in place to form a rigid matrix. The resulting material has the appearance of granite.

The above described processes, as well as other cured resin processes, are in use today and constitute a large industry. That industry is referred to here generally as the cultured marble industry.

FIG. 2 (Prior Art) is a simplified diagram that illustrates the distribution of starting materials in the cultured marble industry. The industry includes relatively small number of relatively large manufacturers of filler material and resin. The two ovals in the upper row in FIG. 2 represent one resin manufacturer and one filler manufacturer. Reichold Chemicals Inc. is an example of a resin manufacturer. Alcoa, Pfeister and Gergia Pacific are an examples of filler manufacturers.

The industry also includes a relatively large number of fabricators of cured resin products. There are thousands of small fabricators across the United States. These fabricators typically purchase resin from the resin manufacturers through distributors. A large fabricator may purchase resin directly from a resin manufacturer. The ovals in the bottom row of FIG. 2 represent the relatively large number of fabricators. An “L” in an oval indicates that the fabricator is a large fabricator. Note that the leftmost fabricator oval having an “L” receives resin directly from the resin manufacturer, whereas the smaller fabricators that are not denoted with an “L” receive resin through a distributor.

In the same way that resin is manufactured by a relatively small number of relatively large manufacturers, so too is the filler manufactured by a relatively small number of relatively large manufacturers. The filler manufacturers typically sell filler to fabricators through distributors. Distributors may resell both resin and filler, or may resell just filler. In the case of a particularly large fabricator, the filler manufacturer may sell filler directly to the fabricator. This is represented by the dashed arrow that extends directly from the oval labeled “filler manufacturer” to the rightmost two ovals in the bottom row that contain the letter “L”. In FIG. 2, the transfer of resin is indicated by solid lined arrows. The transfer of filler is indicated by dashed lined arrows.

FIG. 2 illustrates a simplification of the flow of starting materials. There are many different supply and purchasing arrangements not illustrated in the simplified diagram. In general, however, a fabricator purchases resin and filler as separate materials. The resin is received in one container. The filler is received in another container. The fabricator mixes the resin and filler at the fabricator's factory or shop, adds catalyst, and goes through the process set forth in FIG. 1.

Because the fabricator is purchasing resin and filler separately, the fabricator must generally make sure that enough inventory of both resin and filler (and any other ingredients such as pigment) are on hand at the fabricator's factory to sustain production and meet demand without over purchasing. Maintaining good inventory control takes time and energy. Overstocking of material can result in a loss of working capital and an interest expense. Fabricators who prepare small batches of material may have difficulty mixing starting materials in as precise of proportions as would be optimal. The consistency of the resulting material may therefore vary from batch to batch. Where filler is purchased from one source and resin is purchased from another source, two different sets of financial transactions and accounts must be maintained. Transportation costs associated with receiving multiple deliveries due to the multiple different sources of starting materials may be incurred. More efficient and improved methods and techniques for making cured resin articles are desired.

### SUMMARY

A non-catalyzed mixture of resin and filler, in the proper proportions for use in the manufacture of cast resin articles, is packaged into an airtight shipping and dispensing container. The mixture may be vacuum-packed into the airtight container, or may be placed into the container in less than one atmosphere of pressure. A relatively large amount of resin and filler mixture in the approximate range of from one hundred to five hundred pounds is typically contained in such a container. Rather than supplying resin and filler starting materials to fabricators as separate materials, the resin and filler starting materials are supplied to fabricators in a pre-mixed condition in airtight shipping and dispensing containers.

In accordance with one embodiment, a fabricator uses a novel dispensing and mixing machine to extract a desired amount of non-catalyzed resin and filler mix from the container. The dispensing and mixing machine mixes a catalyst into the extracted mixture and the resulting catalyzed mixture is output from the machine and is placed into molds. The mixture is allowed to harden and cure. The hardened material, which forms the desired cast article, is then removed from the mold.

Numerous cost savings and efficiencies can be realized as set forth in the detailed description below. Quality and uniformity of the resulting articles is facilitated. Inventory control can be simplified. Efficiencies in the distribution and transport of the starting materials can be realized.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (Prior Art) is a flowchart of a conventional process for making cast resin articles.

FIG. 2 (Prior Art) is a diagram that illustrates distribution of starting materials in the cultured marble industry.

FIG. 3 is a flowchart of a method in accordance with one embodiment of the present invention.

FIG. 4 is a diagram that illustrates distribution of resin and filler in accordance with an embodiment of the present invention.

FIG. 5 is a diagram of a dispensing and mixing machine in accordance with one embodiment of the present invention. A non-catalyzed resin and filler mixture is contained in a novel airtight shipping and dispensing container. The dispensing and mixing machine is forcing non-catalyzed resin out of the container and into a mixer. The mixer combines the resin and filler mixture with a catalyst and the resulting catalyzed mixture exits the dispensing and mixing machine and is directed into a mold.

FIG. 6 is a simplified diagram of another novel airtight shipping and dispensing container. The container is being squeezed between two plates such that a non-catalyzed resin and filler mixture is forced out of the container.

FIG. 7 is a simplified diagram of an airtight shipping and dispensing container. In the example of FIG. 7, an end of the container is wrapped around a rod such that a non-catalyzed resin and filler mixture is forced out of the container.

FIG. 8 is a simplified diagram of another novel airtight shipping and dispensing container. The container includes a shipping pallet that can be moved by a forklift. An amount of non-catalyzed resin and filler mixture is contained in an airtight bag. The bag is supported by the walls of the pallet.

### DETAILED DESCRIPTION

Reference will now be made in detail to some embodiments of the invention, examples of which are illustrated in the accompanying drawings.

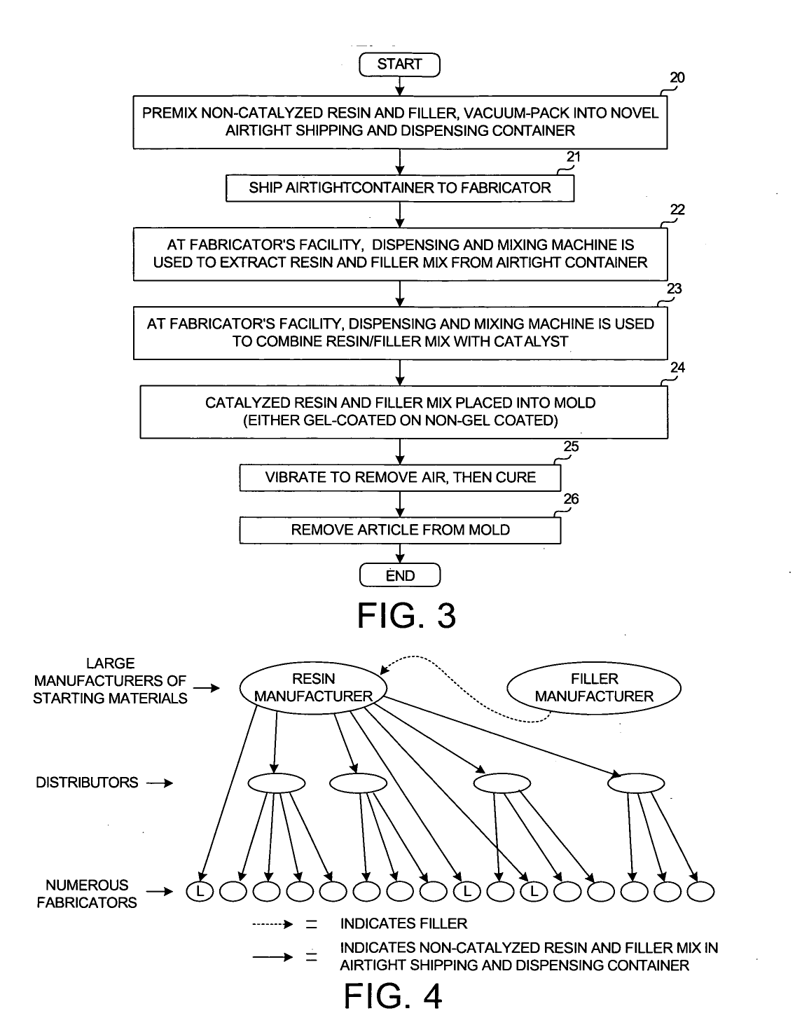

FIG. 3 is a simplified flowchart of a method in accordance with one embodiment of the present invention. A non-catalyzed mixture of polyester resin and filler is pre-mixed and vacuum-packed (step 20) into a novel airtight shipping and dispensing container. The polyester resin may, for example, be the polyester resin typically used in the production of cultured marble. The filler may, for example, be the calcium carbonate typically used in the production of cultured marble. Although the example described here involves polyester resin and calcium carbonate, other resins and other filler materials may be used in other embodiments.

In one example, the airtight shipping and dispensing container has the form of a common tube of caulk of the type commonly used with a handheld caulk gun. The shipping and dispensing container has a plastic nozzle extension at one end of a cylinder. The nozzle extension has a substantially tubular form. The end of the nozzle extension can be cut off to form a nozzle through which the resin and filler mixture can be dispensed from the container. A piston is disposed in the cylinder. The piston can be pushed axially into the cylinder in the direction of the nozzle extension so as to force the resin/filler mixture in the cylinder outward through the nozzle. Unlike a tube of common caulk, however, the shipping and dispensing container of the present invention is large. In this embodiment, the container contains approximately two hundred pounds of resin/filler mix. In the present example wherein the resin is a polyester resin and wherein the filler is calcium carbonate, the mixture is approximately twenty weight percent resin and has the consistency of runny cookie dough.

In this example, the filler is manufactured by a filler manufacturer, and is then shipped to a resin manufacturer. The resin manufacturer mixes the resin and filler together in the desired proportion, and then vacuum packs the mixture into the airtight shipping and dispensing container.

Next (step 21), the shipping and dispensing container full of non-catalyzed resin/filler mixture is supplied to fabricators. Fabricators purchase containers full of resin/filler mixture either directly from the resin manufacturer and/or through distributors. The shipping and dispensing container arrives at the facility, factory or shop of the fabricator.

Next (step 22), the fabricator places the container into a novel dispensing and mixing machine and cuts the end of the nozzle extension of the container off to form a nozzle.

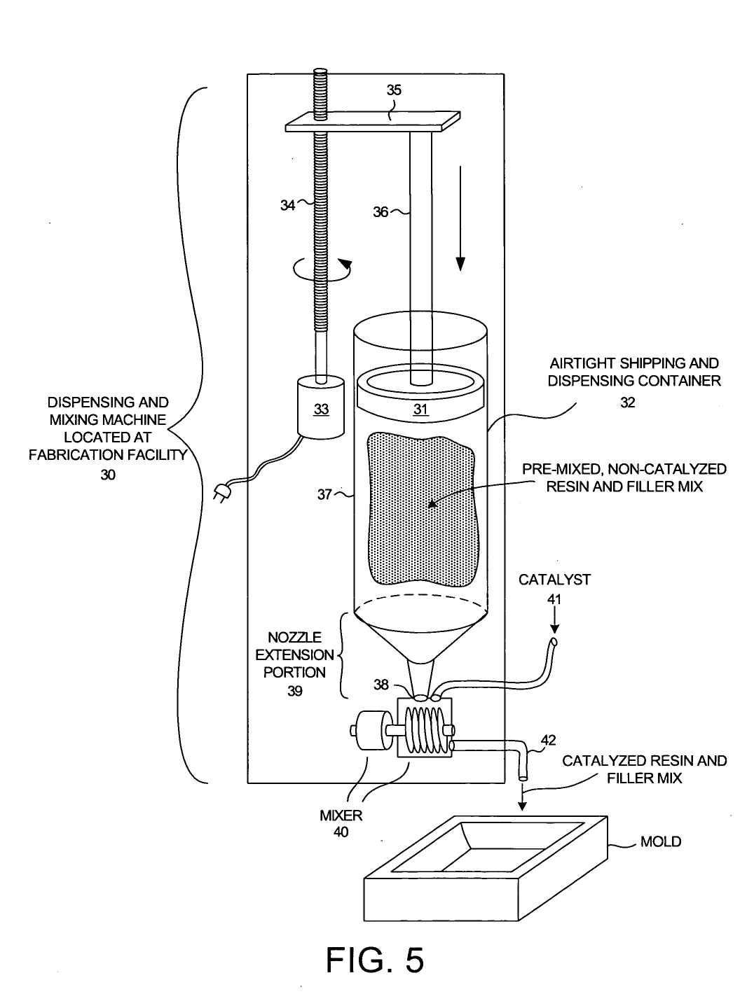

FIG. 5 is a simplified diagram of one example of a dispensing and mixing machine 30. Dispensing and mixing machine 30 includes a mechanism for pushing the piston 31 of the container 32 downward. The mechanism includes an electric motor 33 that rotates a threaded shaft 34. Rotating the shaft 34 forces a threaded rider 35 downward such that a rod 36 forces the piston 31 downward in the axial dimension through the cylinder portion 37 of the container 32. When piston 31 is forced downward, pre-mixed and non-catalyzed resin and filler mix from within the cylinder of the container 32 is extruded (step 22) from the nozzle opening 38 in nozzle extension portion 39. Nozzle opening 38 is placed into an input port of a mixer 40 of the machine. In the illustrated example, mixer 40 is an auger mixer. In addition to an input port for receiving resin/filler mix, the mixer 40 has a second input port for receiving a catalyst 41.

The mixer 40 combines the resin and filler mixture with the catalyst (step 23) and outputs the resulting catalyzed mixture from an output port 42.

The catalyzed resin and filler mixture is placed (step 24) into a mold 37. In the present example, the mold is gel coated with a partially cured thin layer of polester resin.

Once the mold is filled with the catalyzed resin and filler mixture, the mold is optionally vibrated (step 25) in a low pressure atmosphere. Vibrating the mixture in the low pressure atmosphere serves to facilitate the release of any air bubbles that might be adhered to the gel coated mold. The mixture in the mold is then allowed to cure and harden. Once hardened, the finished cast resin article is removed (step 26) from the mold.

Although not illustrated in FIG. 5, dispensing and mixing machine 30 may include a hoist usable to lift the container 32 into place and/or to remove the container from the dispensing and mixing machine 30. To grab the container, the hoist includes a cable that terminates in a sling. The sling is fashioned to catch the bottom nozzle extension portion 39 of the container and to hold and support the container in place.

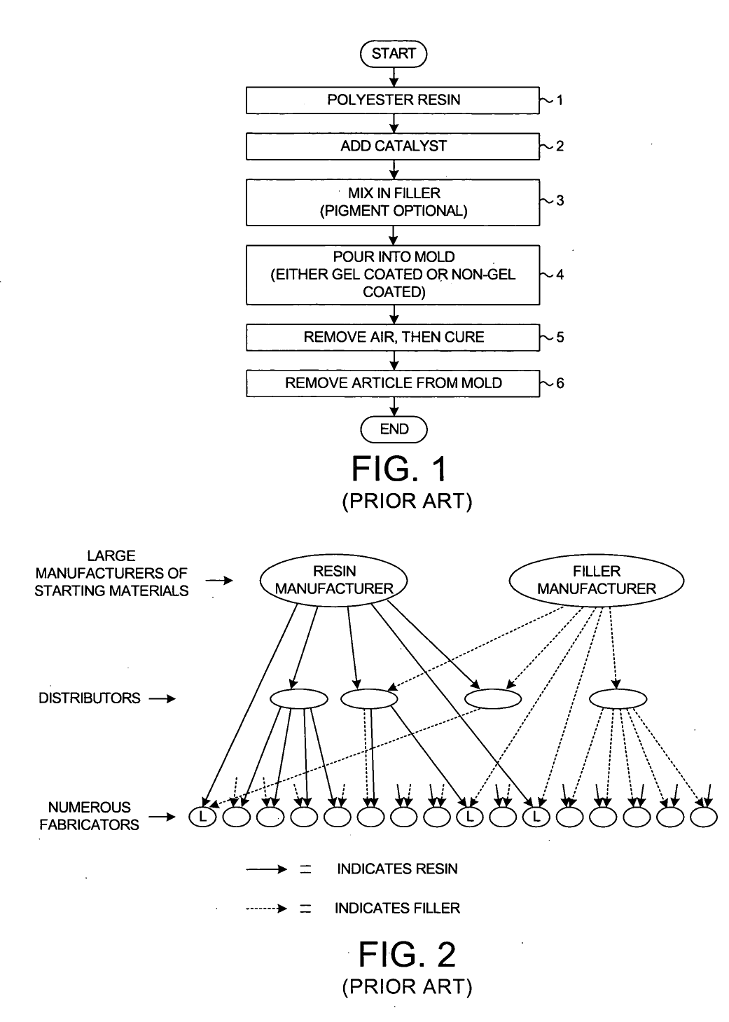

The method of FIG. 3 has several advantages over the prior art method of FIG. 1.

First, the fabricator does not need to mix the proper proportions of resin and filler because these two starting materials are supplied in the container in pre-mixed form. The mixing therefore is conducted in a relatively more controlled environment at the resin manufacturer rather than being conducted in smaller batches by personnel who mix a relatively smaller volumes of material. Better mixing consistency and proportion of ingredients is facilitated by performing the mixing at a larger facility (for example, the resin manufacturer) as compared to the smaller fabricator's facility.

Second, inventory control is simplified for the fabricator because numerous ingredients (resin, and filler, and possibly other ingredients in the non-catalyzed mixture) do not have to be ordered by the fabricator and kept on hand at the fabricator's plant.

Third, air quality can be improved in the fabricator's plant because resin does not have to be mixed with fillers by the fabricator. Small fabricators often use open air blade type mixer to perform mixing of the resin and the filler. The release of vapors during this mixing operation is avoided in accordance with the presently described method because the fabricator no longer has to perform this mixing. The resin and filler is supplied to the fabricator in mixed form in an airtight container.

Fourth, only a portion of the contents of a container of resin/filler mix can used. The remainder of the contents of the container has not been exposed to air, and has not been catalyzed. The remainder of the contents can therefore be used at a later date. Partially used containers of resin and filler mix can be removed from the dispensing and mixing machine 30 if desired and set aside for future use. Small amounts of resin and filler mixture as well as larger amounts of resin and filler mixture can be extracted from container 32 without having to calculate the relative amounts of starting materials needed.

Fifth, the distribution of resin and filler starting materials from material manufacturers to the fabricators is simplified. Rather than separately delivering resin and filler to fabricators and trucking or otherwise transporting the starting materials to the fabricators separately, both the resin and the filler are transported to the fabricator at the same time. The number of deliveries to the fabricator can therefore be reduced. Reduction of transportation costs serves to reduce the production cost of the ultimate cast resin articles.

Sixth, unnecessary distribution channels that were previously necessary to supply filler separate from resin can be eliminated. A filler manufacturer, rather than having to sell and supply to numerous distributors, need merely sell and supply filler starting material to a resin manufacturer. This eliminates the need for numerous distribution channels. Efficiencies due to higher volumes in the remaining distribution channels are possible.

FIG. 4 is a simplified diagram that illustrates how the non-catalyzed resin and filler mixture may be distributed in accordance with one embodiment of the present invention. Filler is supplied by the filler manufacturer to the resin manufacturer. This is indicated by the dashed arrow extending to the left to the oval labeled resin manufacturer. The filler is then mixed with resin by the resin manufacturer. The non-catalyzed resin and filler mixture is loaded into airtight containers as set forth above. The containers are then supplied to the many smaller fabricators either directly or through distributors. The solid arrow lines in FIG. 4 illustrate the transport of containers of resin/filler mix. Large fabricators, such as the fabricators indicated by the ovals in the bottom row containing the letter “L”, can be supplied with containers of resin/filler mix directly from the resin manufacturer.

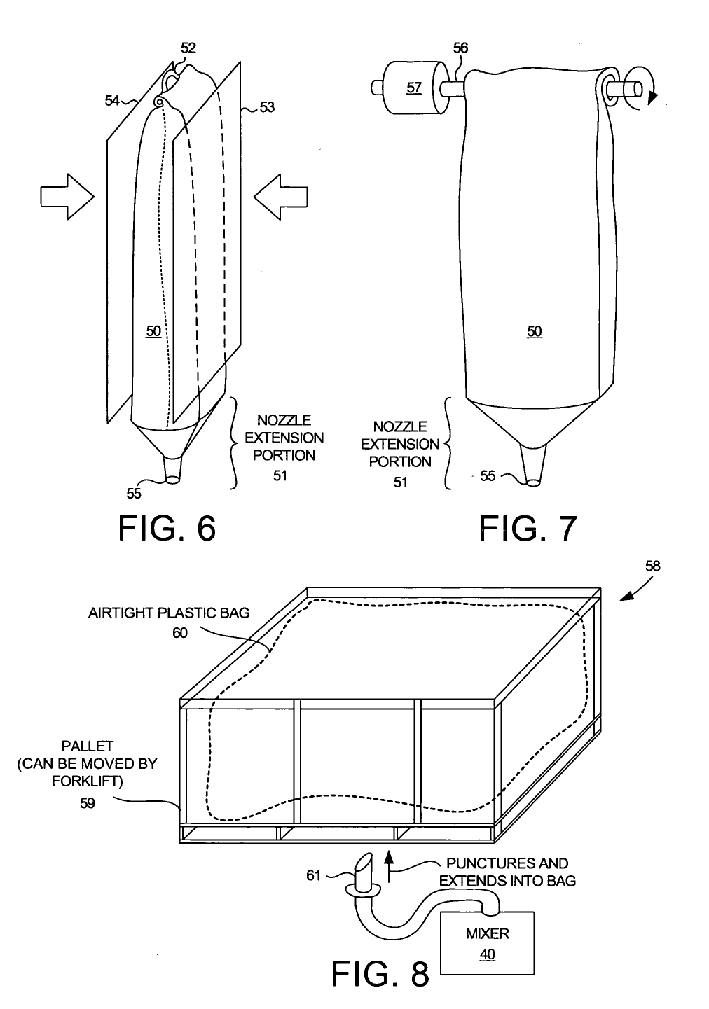

FIG. 5 illustrates but one example of a suitable resin/filler container. Numerous other types of containers can be used. FIG. 6 illustrates a container 50 that has a soft-sided tubular form similar to the form of tube of common toothpaste. Rather than being a small tube containing toothpaste, however, the container is very large and contains approximately two hundred pounds of resin/filler mix. One end of the tube terminates in a nozzle extension portion 51. The opposite end of the tube terminates in a seam. An eye 52 can be provided such that the container can be picked up by a forklift of hoist. The container has no piston. Rather, a dispensing and mixing machine forces the resin/filler mix out of the container by pressing two plates 53 and 54 together. When the plates are pressed together, the resin/filler mix is forced out through the nozzle 55 in the nozzle extension portion 51.

FIG. 7 illustrates a container of the same construction as that of FIG. 6. In the example of FIG. 7, however, the dispensing and mixing machine includes a motorized rotating axle 57. The eye 52 is hooked onto the axle 56. An electric motor 57 rotates axle 57 such that the soft-sided tube of the container is wrapped around the axle 57 and such that the resin/filler mixture is forced out of nozzle 55.

FIG. 8 is a diagram of another novel airtight shipping and dispensing container 58. The container 58 includes a shipping pallet 59 that can be moved by a forklift. Non-catalyzed resin and filler mixture is contained in an airtight bag 60. The bag acts as a bladder and is supported by the bottom and sidewall members of the pallet. In this example of an airtight container, there is no nozzle. Rather, the dispensing and mixing machine employed at the fabricator's facility include a mechanism 61 for puncturing the bag 60. Once the bag has been punctured, the non-catalyzed resin and filler material is extracted through the mechanism 61 and is supplied to the mixer 40 of the dispensing and mixing machine.

Although not illustrated here, the bag of the pallet style container 58 of FIG. 8 may include a nozzle extension portion and a nozzle. If only a portion of the mixture within the container is to be used, then the nozzle can be capped and the container can be set aside (for example, by forklift). A container of pre-mixed non-catalyzed resin and filler mix can have a shelf-life of a year or more. Accordingly, when the fabricator desires to use additional resin/filler mixture, the container can be moved back to the dispensing and mixing machine, the nozzle can be uncapped, and the dispensing and mixing machine can be used to extract additional resin/filler mixture from the container.

Although the present invention has been described in connection with certain specific embodiments for instructional purposes, the present invention is not limited thereto. Numerous different types and styles of shipping and dispensing containers can be employed in accordance with the present invention. Numerous different types and styles of dispensing and mixing machines can be employed in accordance with the present invention. Accordingly, various modifications, adaptations, and combinations of various features of the described embodiments can be practiced without departing from the scope of the invention as set forth in the claims.

1. An airtight container that encloses at least two hundred pounds of a non-catalyzed mixture of polyester resin and a filler.

2. The airtight container of claim 1, wherein the airtight container comprises:
a nozzle extension portion;
a rigid cylindrical portion that extends from the nozzle extension portion; and
a piston slidable axially within the rigid cylindrical portion, wherein the non-catalyzed mixture of resin and filler is disposed within the rigid cylindrical portion between the piston and the nozzle extension portion.

3. The airtight container of claim 1, wherein the airtight container comprises:
a nozzle extension portion; and
a tubular soft-sided bag portion that extends from the nozzle extension portion and terminates in a seam.

4. The airtight container of claim 1, wherein the airtight container comprises a bladder, the non-catalyzed mixture being contained within the bladder.

5. The airtight container of claim 4, wherein the airtight container further comprises a pallet portion having a bottom portion and sidewalls, the bladder being disposed on the bottom portion, the bladder being retained on the bottom portion by the sidewalls.

6. The airtight container of claim 1, wherein the non-catalyzed mixture of resin and filler is sealed in the container at a pressure substantially less than one atmosphere.

7. A method, comprising:
packaging at least two hunderd pounds of a non-catalyzed mixture of a polyester resin and a filler into an airtight shipping and dispensing container.

8. A method, comprising:
(a1) extracting a first amount of a non-catalyzed mixture of a polyester resin and a filler from a first airtight container;
(b1) adding a catalyst to the extracted mixture to form a catalyzed mixture;
(c1) placing the catalyzed mixture into a first mold; and
(d1) curing the catalyzed mixture to form a first cast article.

9. The method of claim 8, wherein the first airtight container contains at least two hundred pounds of the non-catalyzed mixture before the extracting of step (a1).

10. The method of claim 9, further comprising:
(e) packaging the non-catalyzed mixture into the first airtight container at a first location; and
(f) shipping the first airtight container from the first location to a second location, wherein steps (a1), (b1), (c1) and (d1) are performed at the second location.

11. The method of claim 10, further comprising:
(a2) extracting a second amount of a non-catalyzed mixture of a polyester resin and a filler from a second airtight container;
(b2) adding a catalyst to the extracted mixture to form a catalyzed mixture;
(c2) placing the catalyzed mixture into a second mold; and
(d2) curing the catalyzed mixture to form a second cast article, wherein steps (a2), (b2), (c2) and (d2) are performed at a third location, and wherein the second airtight container is shipped from the first location to the third location.

12. The method of claim 11, wherein the first location is a facility of a resin manufacturer, and wherein the second and third locations are locations of fabricators of cultured marble articles, and wherein the first airtight container is shipped from the first location to the second location via a distributor, and wherein the second airtight container is shipped from the first location to the third location via the distributor.
